(19) United States
(12) Patent Application Publication
(10) Pub. No.: US 2010/0277525 A1
(43) Pub. Date: Nov. 4, 2010

(54) METHOD OF PRINTING AND PRINTER

(76) Inventors: Jordi Sender, Barcelona (ES); Alex Andrea, Barcelona (ES); Ramon Vega, Sabadell (ES); David Gaston, Barcelona (ES); Joan Jorba, Coral Gables, FL (US); Silvia Miramanda, Barcelona (ES); Sergio Puigardeu, Barcelona (ES); Marti Rius, Barcelona (ES); Angel Martinez, Barcelona (ES)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/741,640

(22) PCT Filed: Nov. 16, 2007
(86) PCT No.: PCT/US07/24042

§ 371 Date: Jun. 22, 2010

(51) Int. Cl. B41J 29/38

(52) U.S. Cl. 347/9

(57) ABSTRACT

A method of printing on a substrate in a page-wide array printer comprises printing on the substrate as the substrate is moved through a printing zone of the printer in a first direction, and printing on the substrate as the substrate is moved through the printing zone in a second direction different to the first direction.

### FIELD OF THE INVENTION

The invention relates to printers and to methods of printing, primarily in page-wide array printers. The invention relates particularly, but not exclusively, to methods of and printers for multi-pass printing in page wide array printers.

### BACKGROUND

In general, a page-wide array printer comprises a substrate transport path and a print head or array of print heads extending the full width of the substrate transport path. Such an arrangement allows the entire width of a substrate to be printed simultaneously. A substrate may be any type of paper, cardboard, plastic film, textile or other sheet-like material.

The print head or array of print heads is usually fixed within the printer, and a substrate on which an image is to be printed is moved past the print head or heads along the substrate transport path. Such a printer usually comprises more than one print head array, each array being for a different colour of ink.

In such printers, the location of the print head arrays within the printer is usually fixed. Thus, a substrate on the substrate transport path always passes beneath the arrays in the same order, meaning ink is always applied to the substrate in the same order. This can be undesirable, as the order in which ink is applied can have affect image quality. Applying yellow ink before cyan ink may produce a different effect to applying cyan ink before yellow ink. In addition, some types of ink always need to be applied first (eg white ink) while some types of ink always need to be applied last (eg metallic ink or a sealing coating). Although, the order of the print head arrays within the printer, or the colour of ink which is supplied to each array, could be altered, this would require the shutting down of the printer while print head arrays are moved or cleaned.

A printer that allows some flexibility in the order in which ink is applied to a substrate is proposed.

### SUMMARY OF THE INVENTION

According to an embodiment of the invention, a method of printing and a page-wide array printer are provided as described in the appended claims.

According to another aspect of the invention there is provided a computer-controlled method of printing images on a substrate, the method comprising causing a printer to print images on the substrate leaving unprinted substrate adjacent or between the images, and causing the printer to return to the unprinted substrate to print a further image upon the unprinted substrate.

According to a further aspect of the invention there is provided a printer arranged to print images onto a substrate, the printer having a control processor,
a memory accessible by the control processor,
at least one print head, and
a substrate transport system, operable to move the substrate under control of the control processor;
wherein the control processor is programmed to:
(i) record in the memory unprinted regions of the substrate that have not had images printed upon them, the unprinted regions existing adjacent or between printed regions of the substrate that have had images printed on them,
(ii) determine whether an image to be printed will fit into an identified unprinted region, and if so,
(iii) operate the substrate transport means to register the identified unprinted region with the print head, and cause the print head to print the image in the identified unprinted region.

### BRIEF DESCRIPTION OF THE DRAWINGS

The invention will now be described, by way of example only, with reference to the accompanying drawings:

FIG. 1 is a schematic view of a page-wide array printer according to one embodiment of the invention;

FIG. 2 is a more detailed schematic view of the substrate transport mechanism and print head arrays of the printer of FIG. 1;

FIG. 3a schematically depicts one embodiment of a method of printing;

FIG. 3b schematically depicts a method of printing in accordance with one embodiment of the invention;

FIG. 4 shows a flow chart setting out the steps of a method of printing in accordance with one embodiment of the invention;

FIG. 5 schematically depicts a further embodiment of a method of printing; and

FIG. 6 shows a flow chart setting out the steps of a method of printing in accordance with the embodiment of the invention depicted in FIG. 5.

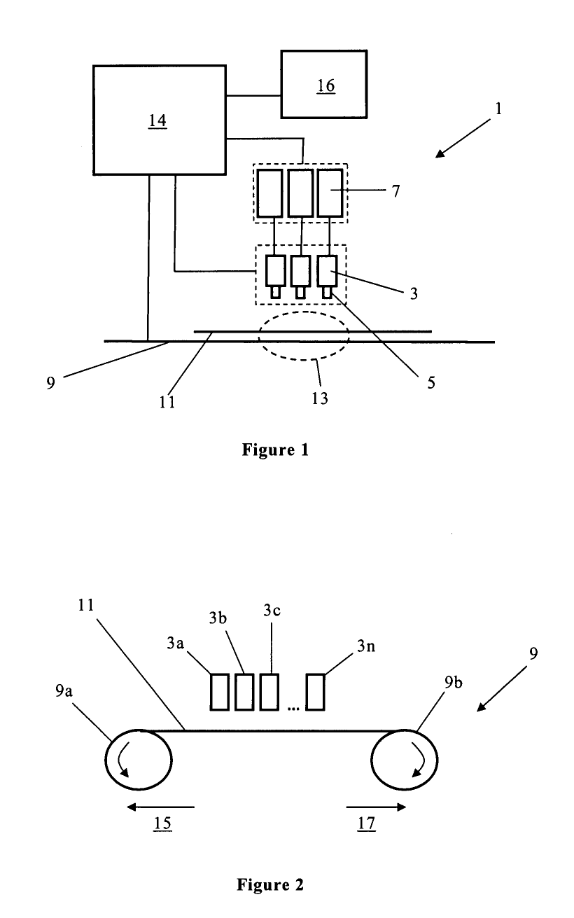

FIG. 1 shows schematically a page-wide array printer 1. The printer 1 comprises one or more print head arrays 3 on which one or more print heads 5 are mounted. The print head array or arrays may comprise a plurality of print heads, such as in of the order of five, fifty, one hundred, or even more. In some embodiments the or each array may comprise only a single print head that is substantially the same length as the array.

Ink is supplied to the print heads 5 in the arrays 3 from a ink tanks 7. In the embodiment shown, the printer comprises a print head array 3 for each colour or type of ink to be printed, shown in more detail in FIG. 2. Each colour of ink has its own ink tank 7.

Each print head comprises a number of nozzles (not shown). The number of nozzles in this embodiment may be in the region of a hundred, five hundred, one thousand, or more. The structure of the print heads and nozzles in this particular embodiment is conventional, and will not be described in detail.

The printer 1 further comprises a substrate transport mechanism 9, which in use is operative to transport a substrate 11 to be printed upon through a print zone 13 below the plurality of print head arrays 3. The substrate transport mechanism 9 is operable to transport substrate through the print zone 13 in at least two different directions, as described in more detail below.

A printer controller 14, such as a microprocessor, for example, is operative to control the firing of the nozzles and the movement of the substrate through the print zone 13. The printer controller also controls the supply of ink to the print heads 5 from the ink tank(s) 7. It will be appreciated that although one controller is shown, separate controllers could instead be provided for each of the substrate transport mechanism 9, the print heads 5, and the ink supply to the print heads.

The controller has access to a memory 16 (for example a computer memory such as a solid-state RAM). Images or jobs for the printer to print are stored in memory 16 until they have been printed onto a substrate by the printer. The memory is also operable to store information concerning the locations of any unprinted space on a substrate, as will be explained in more detail below.

FIG. 2 shows the substrate transport mechanism and print head arrays of FIG. 1 in more detail. The transport mechanism 9 comprises two rollers, 9a and 9b, onto which the substrate 11 is wound. The first roller 9a can be turned to pull substrate from the second roller 9b through the print zone 13 in a first direction, indicated by arrow 15. The second roller 9b can be turned to pull substrate from the first roller 9a through the print zone 13 in a second direction, indicated by arrow 17, opposite to the first direction. Thus a printer with such a substrate transport mechanism is reversible, as media can be moved beneath the print heads 5 in either the first direction or the second direction. Many print jobs can be printed on a single roll of substrate.

The printer comprises a number of print head arrays 3a, 3b, 3c, . . . , 3n. In this embodiment, each array is supplied with a different colour of ink. In other embodiments some arrays might be supplied with more than one colour of ink, or there might exist only one array, which is supplied with every colour of ink. Providing an array for every type of ink may result in a very large printer, so in some embodiments a single array might be provided for less regularly used inks, such as novelty inks (eg metallic, fluorescent, varnish). That ‘novelty’ array can be removable or swappable so that different types of novelty ink can be swapped into and out of the printer, as required.

The arrays 3 are fixed in position with respect to the substrate transport directions 15 and 17, although some lateral movement of the array in a direction which is different (for example substantially parallel to the longitudinal extent of the array), may be permitted. For example, this might be desirable to offset one printing pass with respect to another to to disguise errors created by a potentially misfiring nozzle.

As in known printers, the order of the arrays is fixed or “hard-coded” in the printer. However, in contrast to existing page-wide array printers, the substrate can move beneath the arrays in two different directions.

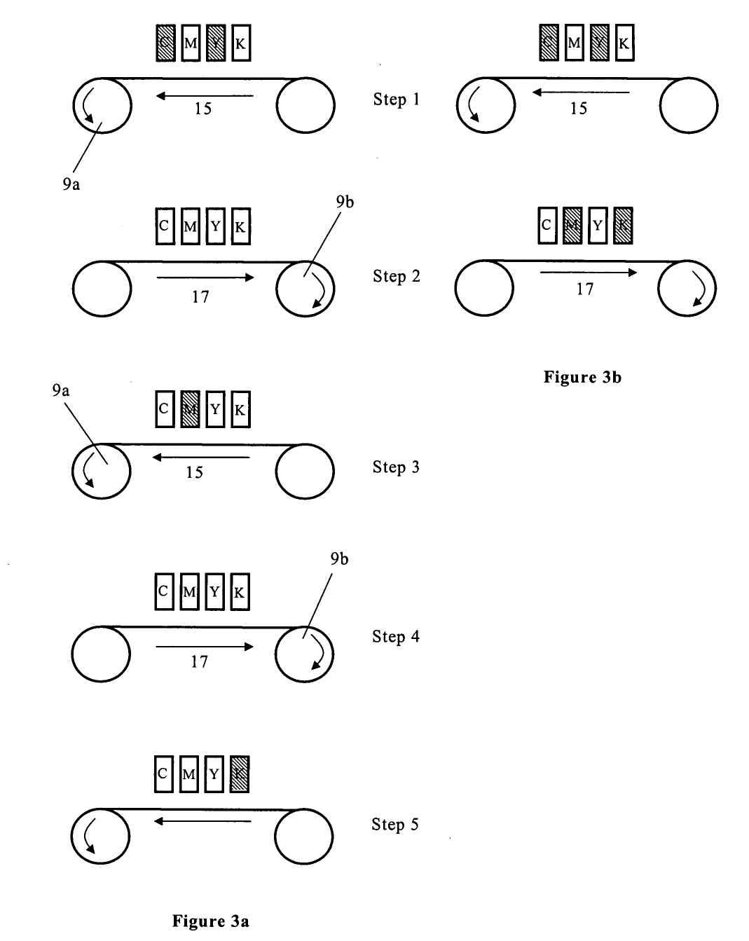

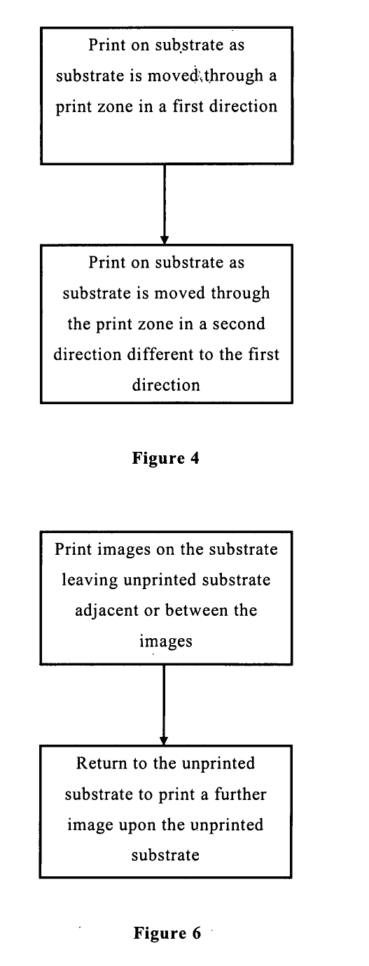

A multi-pass method of printing an image in accordance with the invention will now be described with reference to FIGS. 3a, 3b and 4.

FIG. 3 shows individual printing passes involved in printing an image. In the embodiment shown, ink is required to be printed in a particular order, in this case yellow (Y), cyan (C), magenta (M), and black (K). As can be seen in FIGS. 3a and 3b, the physical order of the print heads in the first direction 15 is black, yellow, magenta, and cyan. It is thus not possible to print ink on the substrate in the required order in a single pass, because ink must be applied to the substrate in the order print head arrays are provided in the printer.

One way that ink could be applied in a different order using a single pass printer would be to physically swap the print heads around, which is time consuming and risks damaging the print heads and wasting ink. Another way might be to duplicate the print heads (eg by providing additional magenta, yellow and black print heads), allowing ink order to vary by changing whether a first or second print head of each colour ink is used. However, there are substantial initial and ongoing (for example, maintenance) costs involved with doubling the number of print heads in a printer.

FIG. 3a shows one way in which the ink could be applied in the desired order without swapping or duplicating the print heads using a multi-pass method. At step 1, substrate is moved beneath the print head arrays in the first direction 15 by turning roller 9a. As substrate moves through the print zone beneath the arrays the yellow ink is printed onto the substrate by array Y followed by cyan ink by array C. The substrate is then rewound onto roller 9b in the second direction 17 in step 2 to return the substrate to its original position. Then a second printing pass follows, in step 3, in which substrate is again wound onto roller 9a in the first direction 15. As the substrate passes beneath the print heads in direction 15 for the second time, magenta ink is printed onto the substrate using array M. In step 4, substrate is again returned to the start of the image by roller 9b. Finally, in step 5, black ink is applied by array K in the third and final printing pass as the substrate passes through the print zone in the first direction 15. Thus by the end of step 5 ink has been applied to the substrate in the desired order YCMK, although this has taken five printing passes rather than one.

In the method of FIG. 3a, in two out of the five steps the printer is not printing while the substrate is returned to the start of the image for the next printing pass.

This means that about two fifths of the operating time of a printer operating according to this method is used in rewinding the substrate.

FIG. 3b shows another method of printing ink in the desired order YCMK using print heads in the same initial order KYMC. Like the method shown in FIG. 3a, yellow and cyan ink is printed in the first printing pass shown in step 1. However, in step 2, at the same time as the substrate is rewound onto roller 9b, magenta ink followed by black ink is printed. Thus, unlike the method of FIG. 3a, the time in which the substrate is being rewound is not wasted, as the substrate is printed on during that time. Thus the number of steps required to print the substrate is reduced from five to two, increasing printing speeds significantly, and still achieving printing with the desired ink order.

In both the method of FIG. 3a and the method of FIG. 3b, the printer controller 14 carefully controls the movement of the substrate to ensure that the second and third passes register with the first, to ensure that the final image is not blurred. This is especially important in printing the second pass in FIG. 3b, which is printed in the opposite direction to the other two passes (ie the pixels making up the image need to be printed in reverse order for the second pass, whilst the substrate is moving in the second direction 17).

It will be appreciated that black ink could be applied in a third printing pass following printing of the magenta ink in the second pass (step 2), if required. However, this would increase the number of steps required from two to three.

The above method of printing one pass in a first direction and a subsequent pass in a second direction different (here, opposite) to the first direction allows very flexible printing. This is because ink can be applied to the paper in any order for any print job. The ink order can be varied from one print job to the next, without the need for printer downtime while the print heads are rearranged. This is particularly useful when different types of substrate are used for different print jobs, because different substrates may have different properties (eg porosity, texture, thickness, etc) which require ink to be applied in a particular order.

The method can be generalised to any number of print head arrays 3n, as shown in FIG. 2. As shown in FIGS. 3a and 3b, more than one type of ink can be printed in each pass if permitted by the print head order.

It will be appreciated that the methods of multi-pass printing described herein are not limited to use with roll to roll printers, as shown in the drawings, but are equally applicable to other types of printer, such as drum printers or flat-bed printers.

Multi-pass printing itself is advantageous as less ink is applied to the paper in each pass, allowing higher quality images to be produced. For example, the unwanted effects of grain and coalescence are reduced when there is lower ink flow. The method allows the printer to run at lower temperature (as nozzles are generally firing less often), which increases print head reliability. In addition, higher optical density images can be produced, as more ink overall can be applied to the paper during multiple passes than in a single pass.

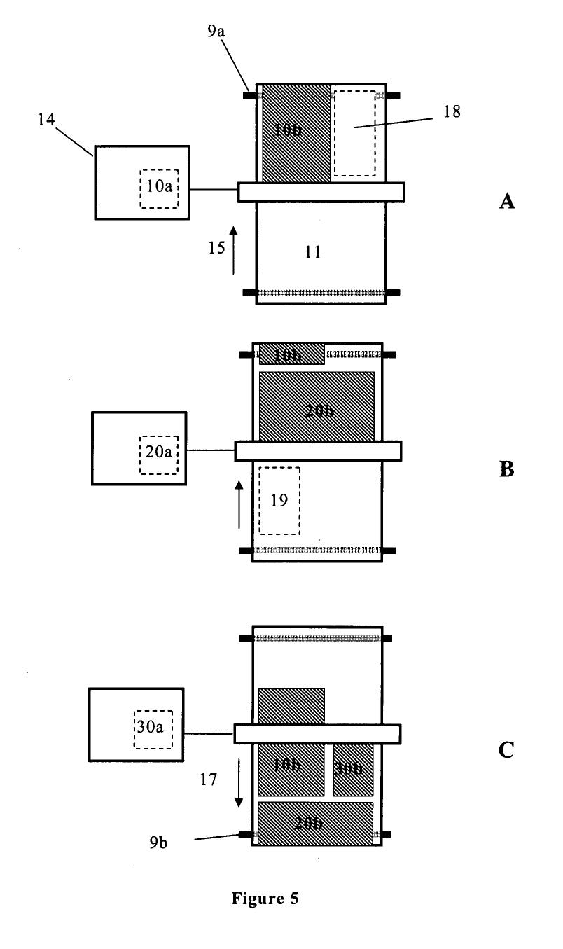

FIGS. 5 and 6 depict an alternative and/or complimentary method to the method described above.

It is well known for a printer controller 14 to store jobs which are to be printed in the printer memory 16 as a ‘queue’. Jobs are usually only stored until they are printed, and are then deleted. If a number of jobs are received simultaneously, the printer controller may reorder those jobs to print them in an order which minimises waste paper. However, if print jobs are received sequentially, they are simply printed one after the other, in the order in which they are received by the controller. This can result in large amounts of substrate being wasted.

Referring to FIG. 5, in diagram A, a first print job 10a is received at the printer 1 and stored, in some embodiments temporarily, in memory 16. That first job 10a is printed as image 10b onto substrate 11 using the print head array or arrays 3. Once printing is complete the job 10a is deleted from memory. The image 10b may be printed in a single pass, whilst substrate or media is moved in the first direction 15 by roller 9a, or in multiple passes, as described above.

The image 10b does not span the full width of the substrate, and an unprinted area of substrate 18 is left adjacent the image 10b. The printer controller 14 takes note of the dimensions and location of the unprinted area 18, and stores that information in the memory 16.

A second print job 20a is received in memory 16 in diagram B of FIG. 5. The controller 14 analyses the second print job 20a and compares the dimensions of the image 20b that will result from that second print job 20a with the dimensions of the unprinted area 18. The controller determines that the second image 20b will be substantially the full width of the substrate, and so will not fit in area 18. The second image is then printed on the substrate following image 10b in sequence. Again, image 20b may be printed in one pass or multiple passes.

In diagram C of FIG. 5, a third print job 3a is received in printer memory 16. In a conventional printer, the third print job would simply be printed sequentially following image 20b in area 19.

However, in the method depicted in FIG. 5, the controller compares the dimensions of the image 30b that will result from that print job 30a with the dimensions of the unprinted area 18, and determines that the third image 30b will fit in unprinted area 18. The substrate 11 is then wound backwards onto roller 9b. The substrate is wound back until the beginning of the unprinted area 18 is reached, at position 22, and then image 30b is printer in direction 17. Image 30b may be printed in single pass, notably in a reverse direction to the single pass printing of images 10b and 20b, or in multiple passes, as desired. Image 30b may of course be printed in the same direction 15 as the other images if required, for example because ink order is important.

The steps of the method are set out in FIG. 6. It is possible for a printer configured according to the method depicted in FIG. 6 to return to unused substrate and print on that substrate, allowing the printer to maximise substrate usage and minimise waste.

It will be appreciated that FIG. 5 is illustrative only, and the printer controller may store the location of many unprinted areas in the memory at the same time. Once an unprinted area has been printed upon, the location of that area is deleted from the memory, or marked as no longer available. If only part of an unprinted area is printed on, the dimensions of the remaining area may be stored in the memory as a new unprinted area. Alternatively, the record stored in the memory of the existing unprinted area may be altered to change the dimensions of the unprinted area to match those of the remaining area.

The controller may compare the size of incoming jobs with the largest unprinted area first, and if an incoming job will not fit into the largest area, the controller may instruct the printer to print that job sequentially. The printer may be configured to print an incoming job in the smallest unprinted area into which it will fit.

Rewinding the substrate to return to unprinted substrate takes time. However, as much as 60% of a substrate may be wasted in a conventional page-wide array printer, and so minimising waste by nesting images can result in large efficiencies, particularly when expensive substrate is being used.

The controller may allow a user to choose between minimising substrate wastage and maximising printer throughput. A compromise may be provided in which the printer will only return to an unprinted region when it will not take too much time to rewind that far, for example when it is less than a predetermined distance, for example five meters, or two meters, from the present location of the print heads in relation to the substrate. The controller may be operable to automatically delete (or mark as not available for printing) the locations of distant (for example greater than five meters from the printing location) unprinted areas from the memory.

The method of nesting images described in FIGS. 5 and 6 is not limited to page wide array printers, and may also be useful in other printers, for example in scanning printers.

1. A method of printing on a substrate in a page-wide array printer, the method comprising:
printing on the substrate as the substrate is moved through a printing zone of the printer in a first direction;
printing on said substrate as the substrate is moved through the printing zone in a second direction different to the first direction.

2. The method of printing of claim 1, wherein the second direction is opposite to the first direction.

3. The method of claim 1 wherein the printer comprises a print head array or arrays capable of printing a plurality of different colours of ink, the method comprising, printing a first ink colour as the substrate is moved in the first direction, and printing a second ink colour as the substrate is moved in the second direction.

4. The method of claim 3 wherein the printer is operable to select the order in which the plurality of ink colours are printed.

5. The method of claim 1, wherein the method further comprises printing on the substrate as the substrate is moved through the printing zone in the first direction for a second time.

6. The method of claim 1, wherein the method further comprises causing a printer to print images on the substrate leaving unprinted substrate adjacent or between the images, and causing the printer to return to the unprinted substrate to print a further image upon the unprinted substrate.

7. The method of claim 6 wherein the printer is operable to store the location and dimensions of one or more unprinted areas of substrate in a printer memory.

8. The method of claim 7 wherein the printer is operable to compare the dimensions of a print job with the dimensions of the one or more unprinted areas stored in memory, and to print on a selected one of those unprinted areas if the dimensions of the print job are such that that print job would fit into the selected unprinted area.

9. The method of claim 7 wherein the printer is operable to perform an operation from the group:
(i) delete the location of an unprinted area from the memory once it has been printed upon;
(ii) flag in the memory as being unavailable to be printed upon an area once that area has been printed upon;
(iii) if part but not all of an unprinted area has been printed upon, store in the memory the dimensions of the remaining unprinted area;
(iv) any combination of (i) to (iii).

10. The method of claim 6 wherein the printer is operable to allow a user to select between increasing throughput and reducing wastage, and wherein if increasing throughput is selected, the printer does not necessarily return to unprinted areas to print upon them.

11. A page-wide array printer comprising:
at least one print head;
a printing zone adjacent said at least one print head; and
a substrate transport mechanism operable to convey a substrate to be printed through the printing zone;
wherein the substrate transport mechanism is operable to convey said substrate through said printing zone in a first direction, and also in a second direction different to the first direction,
wherein the print head is arranged to print on the substrate as it is conveyed through the printing zone in the first direction and as it is conveyed through the printing zone in the second direction.

12. The printer of claim 11 wherein the second direction is opposite to the first direction.

13. The printer of claim 12 wherein the paper transport system comprises a roll-to-roll system.

14. The printer of claim 11, wherein the printer comprises a plurality of print heads operable to print using a plurality of different inks, wherein the print heads are arranged to print using one or more inks as the substrate is conveyed through the print zone in the first direction, and using one or more different inks as the substrate is conveyed through the print zone in the second direction.

15. The printer of claim 14 wherein the different inks comprise different colour inks, and further comprising a printer controller, the printer controller operable to select the order in which the plurality of different colour inks are printed on the substrate.

16. The printer of claim 11, the printer further comprising:
a control processor, and
a memory accessible by the control processor,
wherein the control processor is programmed to:
(i) record in the memory unprinted regions of the substrate that have not had images printed upon them, the unprinted regions existing adjacent or between printed regions of the substrate that have had images printed on them,
(ii) determine whether an image to be printed will fit into an identified unprinted region, and if so,
(iii) operate the substrate transport means to register the identified unprinted region with the print head, and cause the print head to print the image in the identified unprinted region.

17. A computer readable medium comprising a computer program operable when run on a printer to cause the printer to perform the method of claim 1.
